(19) United States
(12) Patent Application Publication
(10) Pub. No.: US 2013/0038043 A1
(43) Pub. Date: Feb. 14, 2013

(54) Telescoping trailer

(71) Applicants: Thomas R. Brown, Oregon, IL (US); Shawn Schwartzrock, Mt. Morris, IL (US); Todd Katzenberger, Forreston, IL (US)

(72) Inventors: Thomas R. Brown, Oregon, IL (US); Shawn Schwartzrock, Mt. Morris, IL (US); Todd Katzenberger, Forreston, IL (US)

(21) Appl. No.: 13/205,479

(22) Filed: Aug. 8, 2011

(51) Int. Cl. B62D 21/14

(52) U.S. Cl. 280/656

(57) ABSTRACT

A telescoping trailer comprises an outer tube frame and at least one inner tube frame. The outer tube frame defines a void space and at least one inner tube frame is constructed and arranged to fit within the void space and slidingly engage the outer tube frame. The trailer has a sliding position and a secured position wherein in the sliding position an inner tube frame slidingly engages the outer tube frame and in the secured position a securing wall of the inner tube frame is secured against a securing wall of the outer tube frame such that the securing walls of the at least one inner tube frame and the outer tube frame are substantially parallel. The portion of the inner tube frame within the outer tube frame while in the secured position defines an over-lap area.

### CROSS-REFERENCE TO RELATED APPLICATIONS

Not Applicable

### STATEMENT REGARDING FEDERALLY SPONSORED RESEARCH

Not Applicable

### FIELD OF THE INVENTION

This invention relates to an extendable trailer.

### BACKGROUND OF THE INVENTION

When transporting long items such as a typical wind blade, a telescoping trailer is often used as it allows the trailer to be shortened to a length that does not require the permit that a longer length trailer does. These telescoping trailers comprise multiple concentric tube frame sections wherein inner concentric sections can slide inside outer concentric sections. When expanded there is an overlap of these concentric sections that is required to maintain the integrity of the trailer structure. It is desirable that the overlap be minimized, but the trade-off is that there is greater transverse movement due to this shortened overlap. This movement can create a dangerous situation as the trailer axles do not track one another and become unaligned. When the frame gets out of alignment, it can result in the trailer axles becoming out of alignment with the tractor axles. The remedy for realigning the trailer has been running a string line the length of the trailer and using a forklift to lift the overlap area and pull it into alignment. Not only is this procedure time consuming and capable of damaging the trailer, it is not uncommon for the trailer to come out of alignment shortly after being aligned after a sharp turn or the like.

Additionally these sections can also generate large binding forces in the overlap areas due to the length and weight of the sections. This makes sliding the sections within one another very difficult, often requiring the use of external assistance such as a fork lift.

Finally the length of these telescoping trailers can cause large displacements due to the harmonic driving forces of the road during over the road transport. These displacements can damage the cargo as sometimes they can be so large as to rise up enough to collide with portions of the cargo.

There is a need for a trailer that protects against misalignment of the trailer axles, reduces the displacements due to harmonic forces, and eliminates large binding effects when attempting to slide the telescoping sections.

The instant invention, with its multiple embodiments as disclosed within this application, fills this need. The art referred to and/or described within this application is not intended to constitute an admission that any patent, publication or other information referred to herein is “prior art” with respect to this invention. In addition, this section should not be construed to mean that a thorough search has been made or that no other pertinent information as defined in 37 C.F.R. §1.56(a) exists.

All US patents and applications and all other published documents mentioned anywhere in this application are incorporated herein by reference in their entirety.

Without limiting the scope of the invention, a brief summary of some of the claimed embodiments of the invention is set forth below. Additional details of the summarized embodiments of the invention and/or additional embodiments of the invention may be found in the Detailed Description of the Invention below.

A brief abstract of the technical disclosure in the specification is provided as well, only for the purposes of complying with 37 C.F.R. 1.72. The abstract is not intended to be used for interpreting the scope of the claims.

### BRIEF SUMMARY OF THE INVENTION

In at least one embodiment of the invention, the telescoping trailer comprises an outer tube frame and at least one inner tube frame. The outer tube frame defines a void space into which at least one inner tube frame can fit. The inner tube frame can slidingly engage the outer tube frame such that the trailer can be shortened and lengthend as desired. The at least one inner tube frame can be secured longitudinally to the securing wall of the outer tube frame. This can be done through mechanical means (e.g. bolted, screwed, pinned, etc., or any combination of these) wherein at least one wall of both the inner and outer frame are held together

In at least one embodiment, a securing wall of at least one inner tube frame includes at least one threaded hole and the securing wall of the outer tube frame has at least one matching hole. In a secured position a clamp bolt having a threaded end is tightened such that it is disposed through at least one matching hole of the outer tube frame and tightened within the at least one threaded hole such that the securing walls of the at least one inner frame is secured against the outer tube frame. The threaded hole in some embodiments is an insert that is affixed within and/or onto the securing wall of the inner tube frame.

In at least one embodiment of the invention, the trailer includes a support arm assembly including a support arm having a connected end and a free end. The connected end can be affixed to the outer tube frame such that in a lowered position the support arm extends from the outer tube frame in a substantially transverse direction and in a raised position the support arm is positioned such that the support arm extends in a substantially longitudinal direction.

In at least one embodiment, in the lowered position the support arm supports the weight of the trailer at an overlap area when the free end is contacting the ground. In this position binding within the inner and outer tube frames can be reduced.

In at least one embodiment, the support arm assembly includes at least one hydraulic cylinder having a frame end attached to the outer tube frame and an arm end attached to the support arm. In some embodiments, the hydraulic cylinder has an extended position coinciding with the lowered position of the support arm and a retracted condition coinciding with the raised position of the support arm.

In at least one embodiment, the free end of the support arm has at least one wheel.

In at least one embodiment, the telescoping trailer has a frame vibration absorber system including a pivot arm, an air spring, and a damping shock absorber.

In at least one embodiment, the frame vibration absorber system is attached to the outer tube frame and the pivot arm has counter weights. The air spring and the shock absorber can be attached to the outer tube frame. The frame vibration absorber system can have 1) a static condition, 2) a downward movement condition, and 3) an upward movement condition. In the static condition the pivot arm can be in a balanced position wherein the pivot arm is balanced between the air spring and the counterweights; in the downward movement condition the pivot arm can rotate such that the counterweights rise and the air spring and the shock absorber extend; in the upward movement condition the pivot arm can rotate such that the counterweights rise and the air spring and the shock absorber retract.

In at least one embodiment, the air spring can be inflated to a pressure that balances the pivot arm such that the pivot arm is substantially parallel to the outer tube frame.

In at least one embodiment, the counterweights are removable such that counterweights can be added or removed to adjust for the natural frequency of the absorber system.

These and other embodiments which characterize the invention are pointed out with particularity in the claims annexed hereto and forming a part hereof. However, for further understanding of the invention, its advantages and objectives obtained by its use, reference should be made to the drawings which form a further part hereof and the accompanying descriptive matter, in which there is illustrated and described embodiments of the invention.

### BRIEF DESCRIPTION OF THE SEVERAL VIEWS OF THE DRAWING(S)

A detailed description of the invention is hereafter described with specific reference being made to the drawing.

FIG. 1 is a perspective view of an embodied section of the telescoping frame.

FIG. 2 is a cross-sectional view of the outer frame and an inner frame in an unsecured condition.

FIG. 3 is a cross-sectional view of the outer frame and an inner frame in a secured condition.

FIG. 4 is a side view of the telescoping frame having a support arm in the extended position.

FIG. 5 is a side view of the telescoping frame having a support arm in the retracted position.

FIG. 6 is a side view of the outer frame having an attached frame vibration absorber system in the static condition.

FIG. 7 is a side view of the outer frame having an attached frame vibration absorber system in the downward movement condition.

FIG. 8 is a side view of the outer frame having an attached frame vibration absorber system in the upward movement condition.

FIG. 9 is a side view of the outer frame having an attached ground engaging vibration absorber system in the static condition.

FIG. 10 is a side view of the outer frame having an attached ground engaging vibration absorber system in the downward movement condition.

FIG. 11 is a side view of the outer frame having an attached ground engaging vibration absorber system in the upward movement condition.

FIGS. 12a-c is a schematic view of the telescoping trailer with tractor.

### DETAILED DESCRIPTION OF THE INVENTION

While this invention may be embodied in many different forms, there are described in detail herein specific preferred embodiments of the invention. This description is an exemplification of the principles of the invention and is not intended to limit the invention to the particular embodiments illustrated. Additionally, within this application the term “longitudinal” refers to the direction along the length of the frame. The term “transverse” refers to the direction perpendicular to the longitudinal direction. “Substantially longitudinal” means a direction that has a greater longitudinal component than transverse component. “Substantially transverse” means a direction that has a greater transverse component than longitudinal component. “Slidingly engage” refers to being able to move under a force that need only overcome static frictional forces rather than mechanical forces due to fastening or binding of a tube.

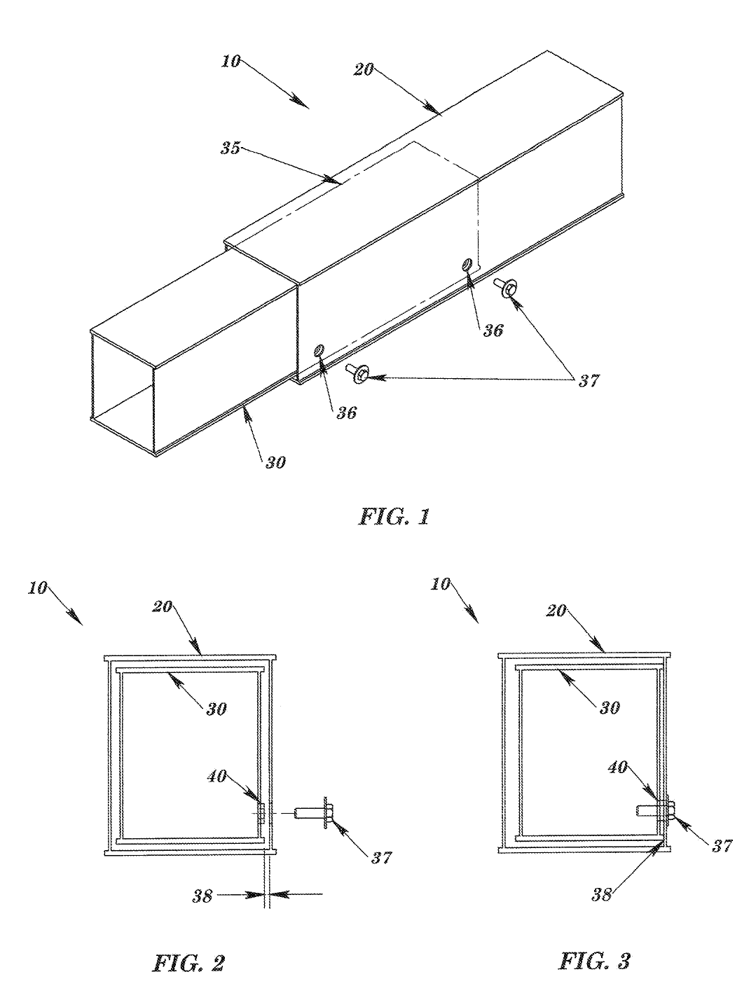

FIG. 1 illustrates a perspective view of an embodied section of the telescoping frame 10. The telescoping frame includes an outer frame tube 20 and an inner frame tube 30 that can slide within the outer frame tube. The frame tube overlap 35 is the section of the telescoping frame in which the inner frame 30 is overlapped by the outer frame 20. Bolt holes 36 within the outer frame 20 are sized to receive clamp bolts 37. The clamp bolts 37 can then extend into inserts 40 that are fastened to the inner frame tube 30 as shown in FIG. 2. By tightening these bolts the gap 38 between the wall of outer frame tube 20 and the inner frame tube 30 can be greatly diminished or eliminated as shown in FIG. 3. By diminishing or eliminating this gap 38 the trailer axles track better than with the gap 38 as the alignment of the axles is consistently maintained. With an unclamped gap there can be more movement between the inner frame tube 30 and the outer frame tube 20 than with a clamped gap. When the trailer axles are out of alignment it can become dangerous for cars on the road.

The inserts 40 can be fit into slots within the wall of the inner tube frame 30. These inserts 40 can be welded to the wall in some embodiments. While inserts 40 are shown in FIGS. 2 and 3, in some embodiments inserts are not used and the wall of the inner frame 30 is threaded. Multiple clamp bolts 37 can be used. In some embodiments three or more are used in an overlap region 35. It should be noted that the length of the overlap region can vary depending on the trailer length required. In some embodiments clamp bolts can be used in more than one wall of the inner tube frame 30. In some embodiments, clamp bolts 37 can be used in the top half of the telescoping frame 10 rather than in the bottom half as shown in the cross-sectional views of FIGS. 2 and 3. In some embodiments, the clamp bolts 37 are used in both the top half and the bottom half to further eliminate possible movement of the inner frame 30 within the outer frame 20.

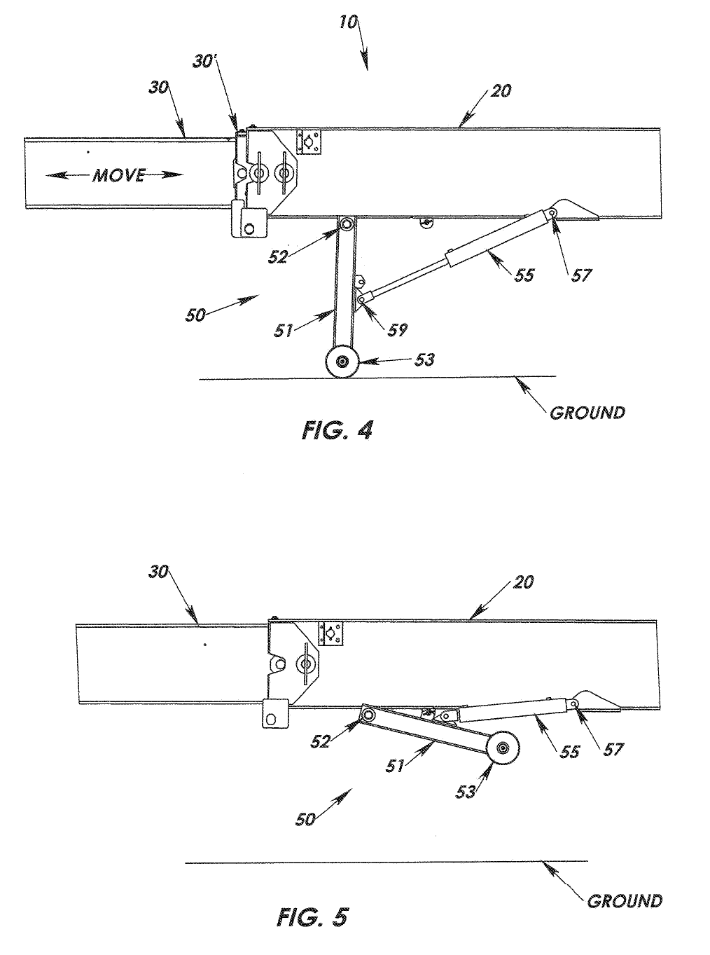

In some embodiments there is more than one inner frame tube 30. In such embodiments an inner frame tube disposed directly about a more inner frame tube can be clamped together similiarly to those described above in that the overlapping inner frame tube is treated as the outer frame tube described above. While the term bolt clamp is used above, other screws, pins, or bolts could be used to diminish the gap 38. Multiple inner frame tubes 30 and 30′ are illustrated in FIG. 4. In some embodiments two or more inner frame tubes can be bolt clamped to the outermost frame tube.

The telescoping trailer can also include a support arm system 50 as illustrated in FIGS. 4 and 5. The support arm system includes a support arm 51 having a connected end 52 that is attached to the outer frame tube 20. The support arm 51 can connect to the outer frame 20 in an overlap region 35 (the overlap region is shown in FIG. 1). The support arm 51 has a free end 53 that contacts the ground when the arm 51 is extended as in FIG. 4. The support arm in some embodiments can be extended by untethering the free end from the outer frame tube 20. In some embodiments, a hydraulic cylinder 55 is also used to assist in controlling the raising and lowering of the support arm 51. The cylinder has a connected end 57 connected to the outer frame tube 20 and an arm end 59 connected to the support arm. In some embodiments the connected end is pivotally connected to the outer frame tube 20 and/or the arm end 59 is pivotally connected to the support arm 51. In the lowered condition the support arm 51 extends in a substantially transverse direction. As shown in FIG. 4 the compressive load at the overlap region is diminished so that the inner frame tubes 30 and 30′ slidingly engage the outer frame tube 20 and/or one another.

After one or more inner frame tubes 30 and/or 30′ are positioned to achieve the desired trailer length, the support arm 51 is often lifted into the retracted condition as shown in FIG. 5. As shown, the hydraulic cylinder 55 retracts such that the support arm 51 is off the ground and extends in a substantially longitudinal direction. In some embodiments the free end 53 includes rolling wheels as shown in FIGS. 4 and 5. In some embodiments the wheels are not present.

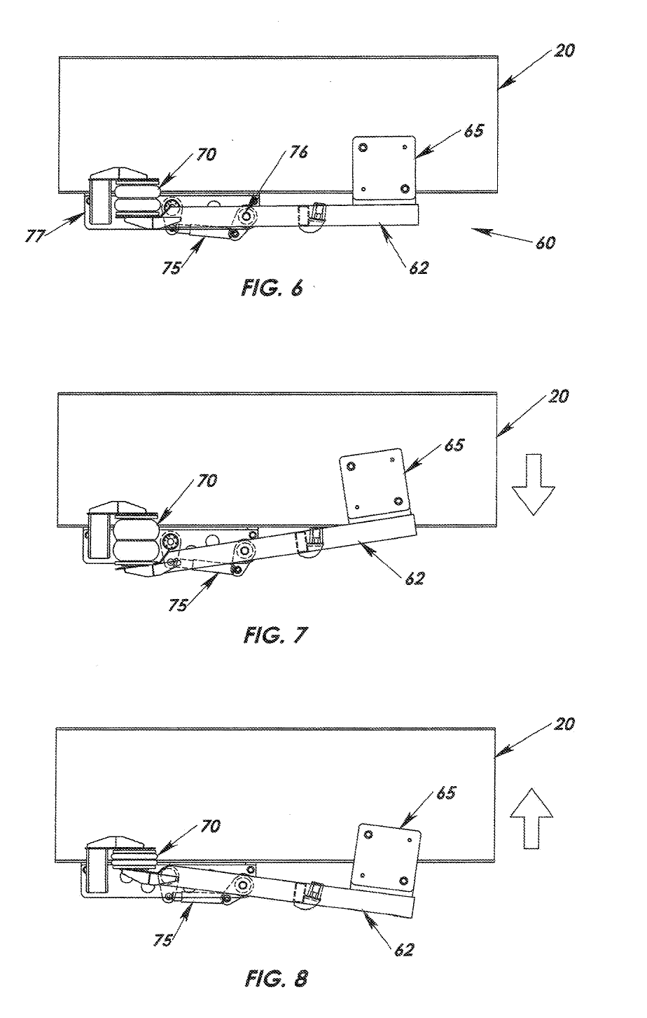

Telescoping trailers need to address not only horizontal movement within the telescoping frames, but also the bouncing effect or vibration of long trailer frames. Large displacements due to the harmonic driving forces of the road during over-the-road transport can be diminished by the frame vibration absorber system 60 illustrated in FIGS. 6-8. The system 60 is shown in a static condition in FIG. 6 and includes a pivot arm 62 having counter weights 65, air springs 70, and a damping shock absorber 75. The pivot arm also has a center of rotation 76. In some embodiments the system 60 is attached to the outer tube 20 by the main frame 77 of the absorber system 60. This main frame 77 supports the fixed end of both the air spring 70 and the damping shock absorber 75.

In the static condition of FIG. 6, the pivot arm 62 of the vibration absorber system 60 is in a balanced position with the outer frame tube 20 of the trailer. In some embodiments the air spring 70 is inflated to a pressure that can balance the pivot arm 62 such that the pivot arm is parallel to the frame 20 tube.

As the trailer experiences the harmonic driving forces from the road, the trailer will begin to bounce at its natural frequency and experience both downward and upward motion. In FIG. 7 the downward motion condition is illustrated. In this condition as the outer frame 20 moves down the counterweights 65 and the pivot arm 62 rotate upwardly. This can cause the air spring 70 and the shock absorber 75 to extend.

In FIG. 8 the upward motion condition is illustrated. In this condition as the outer frame 20 moves up the counterweights 65 and the pivot arm 62 rotate downwardly. This can cause the air spring 70 and the shock absorber 75 to retract.

The motion of the counterweights can lessen the bouncing of the trailer. In some embodiments counter weights can be added or removed to adjust the natural frequency of the absorber system 60. In some embodiments a coil spring is used rather than an air spring. In some embodiments an additional damping shock absorber is used in place of the air spring. In some embodiments an air spring and shock absorber is combined into one component and replaces the use of an individual spring and an independent shock absorber.

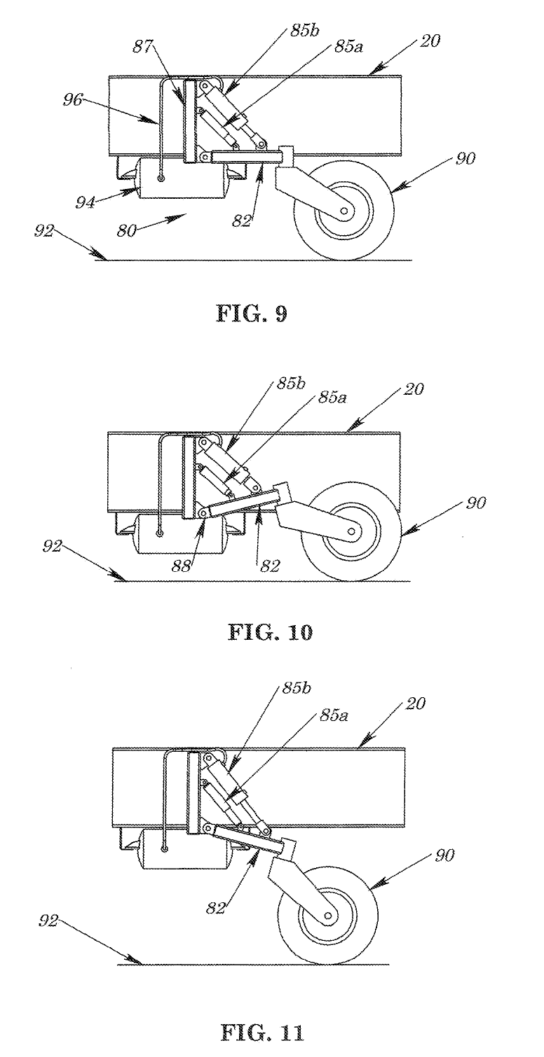

In another embodiment, diminishing the large displacements caused by the harmonic driving forces of the road during over-the-road transport is illustrated in FIGS. 9-11. Here a ground engaging vibration absorber system 80 is used. The system 80 as shown in FIGS. 9-11 includes a pivot arm 82, damping shock absorbers 85a and 85b attached to fixed frame 87. The pivot arm can rotate about joint 88. In some embodiments, the system 80 is attached to the outer tube 20 by the fixed frame 87 of the ground engaging vibration absorber system 80. The pivot arm 82 is attached to a rotational device 90. As shown here the rotational device is a wheel, yet in some embodiments it is spherical. The rotational device 90 engages the ground 92. As used here the ground 92 includes any roadway (paved or otherwise), parking area, loading dock area, or unworked earth. The ground includes any location in which a truck carrying a telescoping trailer may travel. In some embodiments, a pressurized container 94 is included to provide pressure to the damping shock absorbers 85a,b. In some embodiments this is delivered by a line 96. In some embodiments the pressurized container is attached to the damping shock absorber. The pressurized container can be adjustable such that different levels of pressure can be applied to the damping shock absorbers. In some embodiments only one shock absorber 85 is used, in others, 3 or more are used.

The system 80 is shown in a static condition in FIG. 9. Here there is virtually no displacement caused by driving forces. This is most commonly the case when the trailer is at rest.

As shown in FIG. 10 the deflection of the telescoping frame 10 is in the downward direction with respect to the ground 92. Here the rotational device 90 engages the ground and is forced upward in relation to the telescoping frame 10. As the rotational device 90 is attached to the pivot arm 82, the pivot arm 82 rotates upward. The shock absorbers 85 resist compression caused by the rotating pivot arm 82. This resistance assists in lessening the possible displacement of the telescoping frame 10 that would have occurred had the system 80 not been in place.

As shown in FIG. 11 the deflection of the telescoping frame 10 is in the upward direction with respect to the ground 92. Here the rotational device 90 engages the ground and allows the shock absorbers 85 to extend as the pivot arm 82 rotates downward. In this extended state, the shock absorbers allow the rotational device 90 to engage the ground 92 at a point where the outer frame is extended from the rotational device and then as the telescoping frame 10 moves downward the shock absorbers resist compression as the pivot arm 82 rotates upward. This resistance assists in lessening the possible displacement of the telescoping frame 10 that would have occurred had the system 80 not been in place.

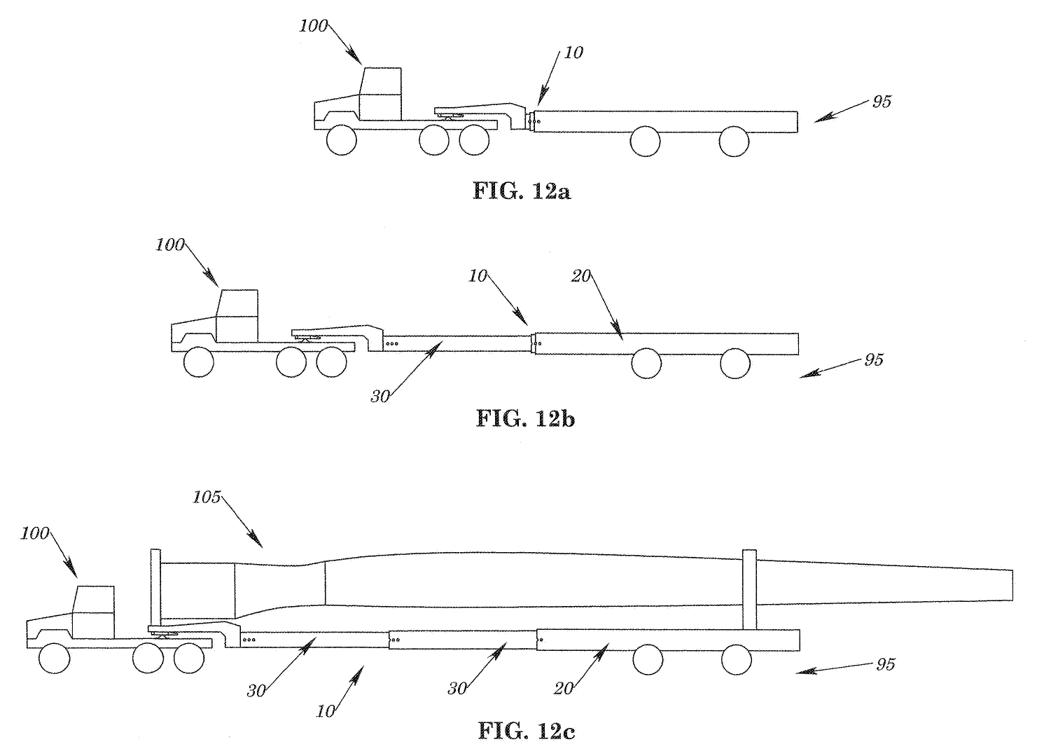

In FIGS. 12a-c the telescoping trailer 95 attached to a tractor 100 is illustrated. In FIG. 12a the telescoping frame 10 of the trailer 95 is in a shortened state. In FIG. 12b the telescoping frame 10 of the trailer 95 is in an intermediate state in which one of the inner frame tubes 30 extends from another inner frame tube 30 and/or the outer frame tube 20. Finally, in FIG. 12c the telescoping frame 10 is fully extended such that the inner frame tubes 30 are fully extended from the outer frame tube 20. Also illustrated in FIG. 12c is a lengthy item 105 to be transported. A wind turbine blade is an example. It should be noted that the trailer 95 does not need to be fully extended in order to transport an item. Additionally more inner frame tubes 30 can be used than the two shown in FIGS. 12a-c. In some embodiments only one inner frame tube 30 is used. Also, the frame tubes 20, 30 can be of many cross-sectional geometries such as circular, elliptical, or other curved geometry. Likewise a triangular, quadrilateral, or other multi-sided geometry might be used. In some embodiments the cross-sectional shapes are that of a regular three or more sided polygon.

For the purposes of this disclosure, like reference numerals in the figures shall refer to like features unless otherwise indicated.

The above disclosure is intended to be illustrative and not exhaustive. This description will suggest many variations and alternatives to one of ordinary skill in this art. The various elements shown in the individual figures and described above may be combined or modified for combination as desired. All these alternatives and variations are intended to be included within the scope of the claims where the term “comprising” means “including, but not limited to”.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

1. A telescoping trailer comprising an outer tube frame and at least one inner tube frame, the outer tube frame defining a void space, the at least one inner tube frame constructed and arranged to fit within the void space and to slidingly engage the outer tube frame, the trailer having a sliding position and a secured position, in the sliding position the at least one inner tube frame slidingly engages the outer tube frame, in the secured position a securing wall of the at least one inner tube frame is mechanically secured against a securing wall of the outer tube frame and held in a substantially fixed longitudinal position, the portion of the at least one inner tube frame within the outer tube frame while in the secured position defines an overlap area.

2. The telescoping trailer of claim 1 wherein in the secured position the securing wall of the at least one inner tube frame and the securing wall of the outer tube frame are screwed together.

3. The telescoping trailer of claim 2 wherein the securing wall of the at least one inner tube frame includes at least one threaded hole and the securing wall of the outer tube frame has at least one matching hole, in the secured position a clamp bolt having a threaded end is tightened such that it is disposed through the at least one matching hole and tightened within the at least one threaded hole such that the securing walls of the at least one inner frame is secured against the outer tube frame.

4. The telescoping trailer of claim 2 such that the securing wall of the at least one inner tube frame and the securing wall of the outer tube frame contact one another.

5. The telescoping trailer of claim 3 wherein the at least one threaded hole is a threaded insert affixed to the at least one inner tube frame.

6. The telescoping trailer of claim 1 having a support arm assembly including a support arm, the support arm having a connected end and a free end, the connected end being affixed to the outer tube frame, in a lowered position the support arm extends from the outer tube frame in a substantially transverse direction, in a raised position the support arm is positioned such that the support arm extends in a substantially longitudinal direction.

7. The telescoping trailer of claim 6 wherein in the lowered position the support arm supports the weight of the trailer at the overlap area when the free end is contacting the ground.

8. The telescoping trailer of claim 6 wherein the support arm assembly includes at least one hydraulic cylinder, the at least one hydraulic cylinder position having a frame end attached to the outer tube frame and an arm end attached to the support arm, the at least one hydraulic cylinder having an extended position coinciding with the lowered position of the support arm and a retracted condition coinciding with the raised position of the support arm.

9. The telescoping trailer of claim 8 wherein in the extended position the support arm extends at an angle within 20 degrees of the transverse direction and wherein when in the retracted position the support arm extends at an angle within 20 degrees of the longitudinal direction.

10. The telescoping trailer of claim 6 wherein the free end of the support arm has at least one wheel.

11. The telescoping trailer of claim 7 wherein in the lowered position the at least one inner tube and the outer frame tube slidingly engage.

12. The telescoping trailer of claim 1 having a frame vibration absorber system, the vibration absorber system including a pivot arm, an air spring, and a damping shock absorber.

13. A telescoping trailer comprising an outer tube frame and at least one inner tube frame, the outer tube frame defining a void space, the at least one inner tube frame constructed and arranged to fit within the void space and to slidingly engage the outer tube frame, the trailer having a frame vibration absorber system attached to the outer tube frame and including an air spring, a damping shock absorber, and a pivot arm having counter weights, the air spring and the shock absorber being attached to the outer tube frame, the frame vibration absorber system having 1) a static condition, 2) a downward movement condition, and 3) an upward movement condition, in the static condition the pivot arm is in a balanced position wherein the pivot arm is balanced between the air spring and the counterweights, in the downward movement condition the pivot arm rotates such that the counterweights rise and the air spring and the shock absorber extend, in the upward movement condition the pivot arm rotates such that the counterweights rise and the air spring and the shock absorber retract.

14. The trailer of claim 13 wherein the air spring is inflated to a pressure that balances the pivot arm such that the pivot arm is substantially parallel to the outer tube frame.

15. The trailer of claim 13 wherein the counterweights are removable such that more or less can be added to adjust for the natural frequency of the absorber system.

16. The trailer of claim 13 having a support arm assembly including a support arm, the support arm having a connected end and a free end, the connected end being affixed to the outer tube frame, in a lowered position the support arm extends from the outer tube frame in a substantially transverse direction, in a raised position the support arm is positioned such that the support arm extends in a substantially longitudinal direction.

17. The telescoping trailer of claim 16 wherein in the lowered position the support arm supports the weight of the trailer at the overlap area when the free end is contacting the ground.

18. A telescoping trailer comprising an outer tube frame and at least one inner tube frame, the outer tube frame defining a void space, the at least one inner tube frame constructed and arranged to fit within the void space and to slidingly engage the outer tube frame, the trailer having a support arm assembly including a support arm, the support arm having a connected end and a free end, the connected end being affixed to the outer tube frame, in a lowered position the support arm extends from the outer tube frame in a substantially transverse direction, in a raised position the support arm is positioned such that the support arm extends in a substantially longitudinal direction.

19. The telescoping trailer of claim 18 wherein the support arm assembly includes at least one hydraulic cylinder, the at least one hydraulic cylinder position having a frame end attached to the outer tube frame and an arm end attached to the support arm, the at least one hydraulic cylinder having an extended position coinciding with the lowered position of the support arm and a retracted condition coinciding with the raised position of the support arm.

20. The telescoping trailer of claim 18 wherein the free end of the support arm has at least one wheel.
